(19) United States
(12) Patent Application Publication
(10) Pub. No.: US 2007/0039765 A1
(43) Pub. Date: Feb. 22, 2007

(54) Controlling method for breaking automatically having safety suspense for electrical wheel chair

(75) Inventor: Mei-Ying Lin, Taichung City (TW)

Correspondence Address: TROXELL LAW OFFICE PLLC, 5205 LEESBURG PIKE, SUITE 1404, FALLS CHURCH, VA, 22041, US

(73) Assignee: Mei-Ying Lin, Taichung City (TW)

(21) Appl. No.: 11/494,607

(22) Filed: Jul. 28, 2006

(30) Foreign Application Priority Data
Aug. 22, 2005 (TW) 094128553

(51) Int. Cl. B60K 1/00

(52) U.S. Cl. 180/65.1

(57) ABSTRACT

The present invention provides a method to automatically and safely stop an electrical wheel chair with breaks. When a disabled person pushes a driving-control joystick, the electrical wheel chair is released to move. When the disabled person releases a driving-control joystick, motors of large wheels stop rotating and the electrical wheel chair is locked to be stopped. A suspense time is used to make the driving more safe lest the disabled person falls.

### FIELD OF THE INVENTION

The present invention relates to a controlling method for automatically breaking; more particularly, relates to controlling an electrical wheel chair with a driving-control joystick by automatically enabling or disabling electromagnetic breaks

### DESCRIPTION OF THE RELATED ART

A traditional wheel chair has mechanical breaks for large wheels. But they are not automatic. A disable person has to push the breaks manually to stop the wheel chair. Regarding those disabled persons who have muscular dystrophy, cerebral palsy, frequently-occurring sclerosis, etc., they have not enough strength from muscle to manually push the breaks. Besides, when the wheel chair is stopped with the breaks, the disable person may fall out because of the abrupt stop. Hence, the prior art does not fulfill users' requests on actual use.

### SUMMARY OF THE INVENTION

The main purpose of the present invention is to provide a controlling method for breaking automatically having a safety suspense without breaking manually and with more safety on driving an electrical wheel chair.

To achieve the above purpose, the present invention is a controlling method for breaking automatically having a safety suspense for an electrical wheel chair, which electromagnetic breaks are enabled or disabled according to driving signals sent from a driving-control joystick of an electrical wheel chair controller.

When a disabled person pushes the driving-control joystick to produce and send at least one driving signal, the electrical wheel chair controller disables a left electromagnetic break and a right electromagnetic break to release a left large wheel and a right large wheel respectively. Then after suspending for a suspense time set by the disabled person, the electrical wheel chair controller drives a left DC motor and a right DC motor to move an electrical wheel chair toward a direction the disabled person desires.

When the disabled person wants to stop driving, the driving-control joystick is released. All driving signals are terminated because the driving-control joystick is no more pushed by the disabled person. When the electrical wheel chair controller receives no more driving signal, the left and right DC motors are stopped being driven so that the electrical wheel chair has no moving energy. Then after suspending for a suspense time set by the disabled person, the electrical wheel chair controller enables the left and the right electromagnetic breaks to lock the left and the right large wheels to stop the electrical wheel chair.

Accordingly, a novel controlling method for breaking automatically having a safety suspense for an electrical wheel chair is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a view showing the flow chart of the preferred embodiment according to the present invention;

FIG. 2 is a view showing the block diagram.

### DESCRIPTION OF THE PREFERRED EMBODIMENT

The following description of the preferred embodiment is provided to understand the features and the structures of the present invention.

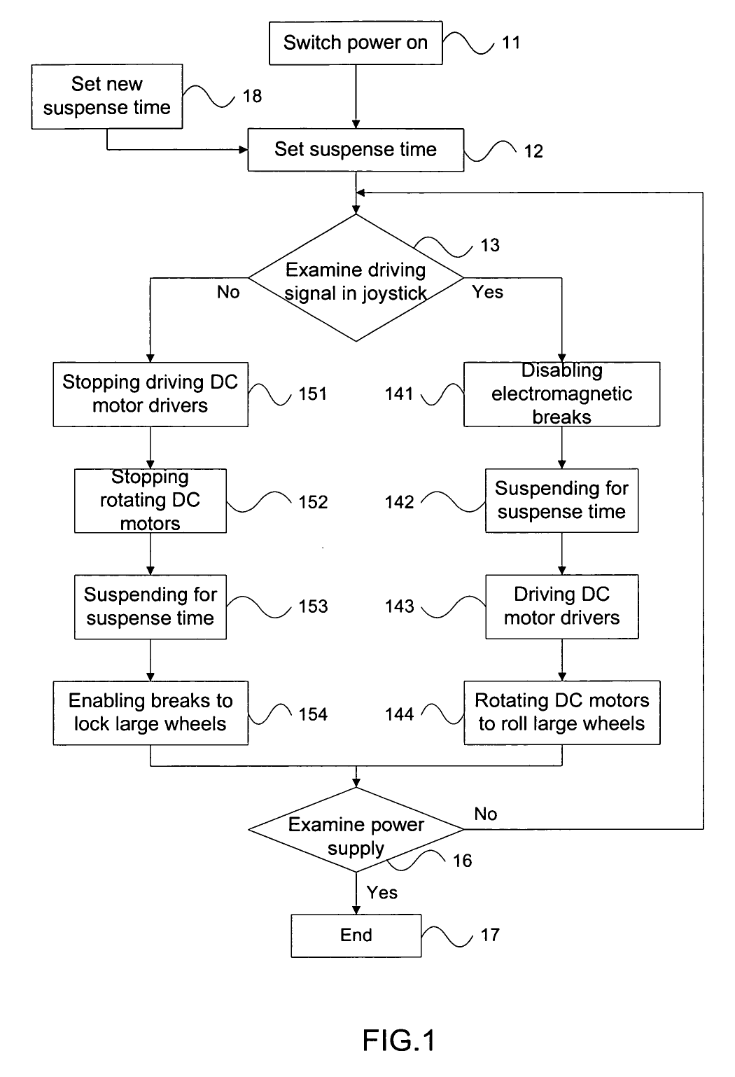

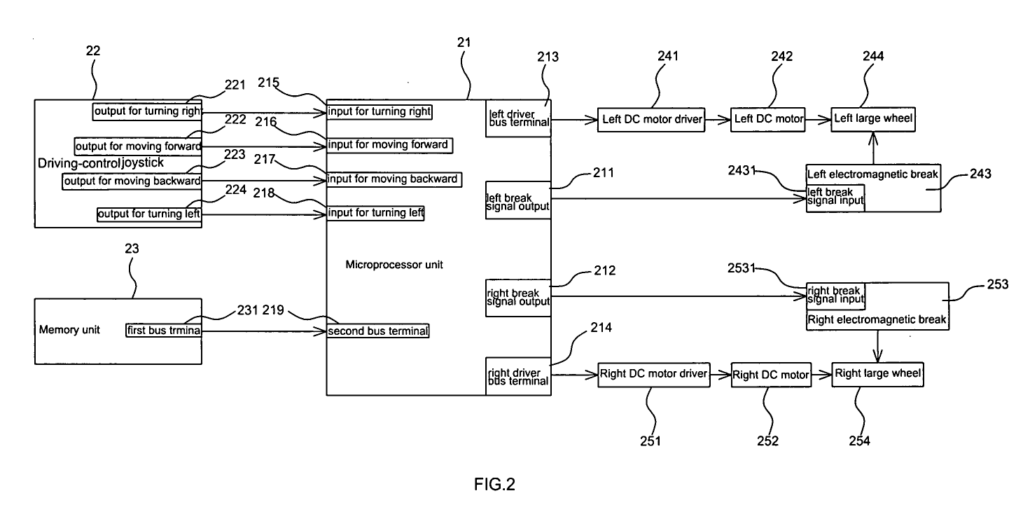

Please refer to FIG. 1 and FIG. 2, which are views showing a flow chart and a block diagram of a preferred embodiment according to the present invention. As shown in the figure, the present invention is a controlling method for breaking automatically having a safety suspense for an electrical wheel chair, comprising the following steps:

(a) Switching Power on 11:

When a disabled person presses a power button, an electrical wheel chair controller is turned on and a controlling program proceeds on executing step (b).

(b) Setting a Suspense Time 12:

If the disabled person wants to set a new suspense time, a step (b1) 18 is processed for the disabled person to set the new suspense time; and the suspense time is used in the electrical wheel chair controller. If the disabled person does not want to set a new suspense time, an original suspense time stored in the memory unit 23 is used in the electrical wheel chair controller. When step (b) is finished, the controlling program proceeds on executing step (c).

(b1) Setting a New Suspense Time 18:

If the disabled person wants to set a new suspense time, the new suspense time is set by the disabled person with an outside device and is stored in a memory unit 23. The suspense time is set to be a time between 0.001 second and 100 seconds.

(c) Examining Whether or Not Any Driving Signal Exists in a Driving-Control Joystick 13:

A driving-control joystick is examined to determine whether or not any driving signal exists in the driving-control joystick.

When the disabled person pushes a driving-control joystick 22 to produce at least one driving signal of the desired direction, the triggered driving signal is inputted to a microprocessor unit 21. Therein, the driving-control joystick 22 is set in the electrical wheel chair controller; the driving signal is a signal of turning right, moving forward, moving backward and turning left outputted from a driving signal output for turning right 221, a driving signal output for moving forward 222, a driving signal output for moving backward 223 and a driving signal output for turning left 224, respectively; and, the driving signal is inputted to the microprocessor unit 21 through a driving signal input for turning right 215, a driving signal input for moving forward 216, a driving signal input for moving backward 217 and a driving signal input for turning left 218. After the microprocessor unit 21 receives the driving signal according to the judging criteria in step (c), a pushing of the driving-control joystick 22 by the disabled person is determined and so at least one driving signal still exists in the driving-control joystick 22. Then the controlling program in the electrical wheel chair controller runs a controlling circuit of “Yes” to proceed on step (d1) to step (d4), as follows: (d1) The microprocessor unit 21 disables a left electromagnetic break 243 and a right electromagnetic break 253 through a left break signal output 211 and a right break signal output 212 to release a left large wheel 244 and a right large wheel 254. (d2) The controlling program is suspended for the suspense time set by the disabled person obtained from a first bus terminal 231 through a second bus terminal 219. (d3) A left direct-current (DC) motor driver 241 and a right DC motor driver 251 start driving a left DC motor 242 and a right DC motor 252. (d4) Then, the left DC motor 242 and the right DC motor 252 are driven to rotate to roll the left large wheel 244 connected with the left DC motor 242, and the right large wheel 254 connected with the right DC motor 252. Thus, an electrical wheel chair moves toward a direction the disabled person desires by pushing the driving-control joystick 22.

When the disabled person releases the driving-control joystick 22, all driving signals are terminated. Those driving signals include driving signals outputted from the driving signal output for turning right 221, the driving signal output for moving forward 222, the driving signal output for moving backward 223 and the driving signal output for turning left 224. Since the microprocessor unit 21 receives no driving signal, according to the judging criteria in step (c), no pushing of the driving-control joystick 22 by the disabled person is determined; and so all driving signals are terminated in the driving-control joystick 22. Then the controlling program in the electrical wheel chair controller runs a controlling circuit of “No” to proceed on step (e1) to step (e4), as follows: (e1) The left DC motor driver 241 and the right DC motor driver 251 stop driving the left DC motor 242 and the right DC motor 252. (e2) The left DC motor 242 and the right DC motor 252 stop rotating and the left large wheel 244 and the right large wheel 254 stop being rolled by the left DC motor 242 and the right DC motor 252. (e3) The controlling program is suspended for the suspense time. (e4) Then the microprocessor unit 21 enables a left electromagnetic break 243 and a right electromagnetic break 253 through a left break signal output 211 and a right break signal output 212 to lock the left large wheel 244 and the right large wheel 254. Thus, the electrical wheel chair stops by releasing the driving-control joystick 22.

In another words, when the controlling program in the electrical wheel chair controller runs the controlling circuit of “Yes”, step (d1) to step (d4) are proceeded, which are described in details as follows:

(d1) Disabling Electromagnetic Breaks to Release Large Wheels 141:

The controlling program disables the left electromagnetic break 243 and the right electromagnetic break 253 to release the left large wheel 244 and the right large wheel 254.

(d2) Suspending for the Suspense Time 142:

The controlling program is suspended for the suspense time which is set by the disabled person and is obtained from the first bus terminal 231 through the second bus terminal 219. With the suspense time, a clear time separation is obtained between step (d1) and step (d3) to maintain a certain sequence of the two steps. Therefore, the two steps are effectively prevented from overlapping owing to slow mechanical motion; and, the large wheel motors 242,252 and the electromagnetic breaks 243,253 are prevented from wearing out owing to being run at the same time. As a result, with the design of the suspense time, a protection is obtained between the large wheel motors 242,252 and the electromagnetic breaks 243,253.

(d3) Driving DC Motor Drivers 143:

The left DC motor driver 241 and the right DC motor driver 251 drive the left DC motor 242 and the right DC motor 252 respectively to start rotating the left DC motor 242 and the right DC motor 252.

(d4) Rotating DC Motors to Roll Large Wheels 144:

The left DC motor 242 and the right DC motor 252 are rotated after being driven by the left DC motor driver 241 and the right DC motor driver 251. Hence the left large wheel 244 connected with the left DC motor 242 and the right large wheel 254 connected with the right DC motor 252 are rolled together. Thus, the electrical wheel chair moves toward a direction the disabled person desires by pushing the driving-control joystick 22.

In the other hand, when the controlling program in the electrical wheel chair controller runs the controlling circuit of “No”, step (e1) to step (e4) are proceeded, which are described in details as follows:

(e1) Stopping Driving DC Motor Drivers 151:

The left DC motor driver 241 and the right DC motor driver 251 stop driving the left DC motor 242 and the right DC motor 252.

(e2) Stopping Rotating DC Motors 152:

The left DC motor 242 and the right DC motor 252 stop rotating once no more being driven by the left DC motor driver 241 and the right DC motor driver 251. As a result, the left large wheel 244 connected with the left DC motor 242, and the right large wheel 254 connected with the right DC motor 252, stop rolling at the same time.

(e3) Suspending for the Suspense Time 153:

The controlling program is suspended for the suspense time which is set by the disabled person and is obtained from the first bus terminal 231 through the second bus terminal 219. With the suspense time, a clear time separation is obtained between step (e2) and step (e4) to maintain a certain sequence of the two steps. Thus, step (e2) and step (e4) are effectively prevented from overlapping owing to slow mechanical motion; and, the large wheel motors 242,252 and the electromagnetic breaks 243,253 are prevented from wearing out owing to being run at the same time. As a result, with the design of the suspense time, a protection is obtained between the large wheel motors 242,252 and the electromagnetic breaks 243,253. In addition, because the left DC motor 242 and the right DC motor 252 are stopped before step (e3), the electrical wheel chair has no moving energy and is slowed down with the weight of the electrical wheel chair itself and the weight of the disabled person. On the contrary, if no suspense time is designed for the electrical wheel chair and is executed at this moment, the electromagnetic breaks 243,253 are enabled to be locked and the electrical wheel chair is stopped immediately right after stopping driving the DC motors 242,252. An inertial force is then produced at the moment so that the disabled person may fall out of the electrical wheel chair owing to having no enough strength to sit firmly in the wheel chair. In the present invention, through the design of step (e3), the electrical wheel chair is naturally slowed down to effectively provide a safe driving of the electrical wheel chair for the disabled person.

(e4) Enabling Electromagnetic Breaks to Lock Large Wheels 154:

After the suspense time, the electrical wheel chair controller enables a left electromagnetic break 243 and a right electromagnetic break 253 to lock the left large wheel 244 and the right large wheel 254 respectively so that the electrical wheel chair is stopped

(f) Examining Whether or Not No More Power is Supplied 16:

If power keeps supplying, an execution of the controlling program jumps to step (c) for a next execution of the controlling program. If no power is supplied, the execution jumps to step (g).

(g) Terminating the Program 17:

The controlling program is terminated.

Nevertheless, a system is used in the present invention with the following components:

(i) Microprocessor Unit 21:

The microprocessor unit 21 has a left break signal output 211, a right break signal output 212, a left driver bus terminal 213, a right driver bus terminal 214, a driving signal input for turning right 215, a driving signal input for moving forward 216, a driving signal input for moving backward 217, a driving signal input for turning left 218 and a second bus terminal 219.

The microprocessor unit 21 is a central processing unit (CPU) of an electrical wheel chair controller, which controlling signals are transferred to a left break signal input 2431 of a left electromagnetic break 243 and a right break signal input 2531 of a right electromagnetic break 253 through the left break signal output 211 and the right break signal output 212.

(ii) Driving-Control Joystick 22:

The driving-control joystick 22 has a driving signal output for turning right 221, a driving signal output for moving forward 222, a driving signal output for moving backward 223 and a driving signal output for turning left 224.

When a disabled person pushes a driving-control joystick 22 to produce at least one driving signal of the desired direction from one of the above driving signal outputs 221,222,223,224, the triggered driving signal is transferred to a driving signal input of the microprocessor unit 21 through a transferring wire, which the driving signal input is the driving signal input for turning right 215, the driving signal input for moving forward 216, the driving signal input for moving backward 217 and the driving signal input for turning left 218. According to the triggered driving signal received, the microprocessor unit 21 disables the left electromagnetic break 243 and the right electromagnetic break 253 (to release large wheels 244,254) through the left break signal output 211 and the right break signal output 212 respectively. After suspending for a suspense time set by the disabled person obtained through a first bus terminal 231, the microprocessor unit 21 drives a left DC motor driver 241 and a right DC motor driver 251 through the left driver bus terminal 213 and the right driver bus terminal 214 respectively. Then a left DC motor 242 and a right DC motor 252 are driven by the left DC motor driver 241 and the right DC motor driver 251 respectively to start rotating. Consequently, the left large wheel 244 connected with the left DC motor 242 and the right large wheel 254 connected with the right DC motor 252 are rolled together. Thus, an electrical wheel chair moves toward a direction the disabled person desires by pushing the driving-control joystick 22.

When the disabled person releases the driving-control joystick 22, all driving signals are terminated. Then the microprocessor unit 21 stops driving the left DC motor driver 241 and the right DC motor driver 251 to stop the left DC motor 242 and the right DC motor 252. After suspending for the suspense time set by the disabled person obtained through the first bus terminal 231, the left electromagnetic break 243 and the right electromagnetic break 253 are enabled (to lock large wheels 244,254) through the left break signal output 211 and the right break signal output 212 respectively so that the electrical wheel chair is stopped.

(iii) Memory Unit 23:

A controlling program of the controlling method according to the present invention is obtained by a computer software to be stored in a memory unit 23 to be used by the microprocessor unit 21 to execute all controlling actions of the electrical wheel chair. The memory unit 23 is a one-time programmable read-only memory (OTPROM), an electrically erasable programmable read-only memory (EEPROM), a flash memory, or a built-in memory in a central processing unit (CPU)

(iv) Left DC Motor Driver 241:

The left DC motor driver 241 receives a control signal from the microprocessor unit 21 to drive the left DC motor 242 to rotate or stop.

(v) Left DC Motor 242:

The left DC motor 242 is driven by the left DC motor driver 241 to roll the left large wheel 244 and to further move the electrical wheel chair. Or, the left DC motor 242 stops rotating and is coordinated with the left electromagnetic break 243 to stop the electrical wheel chair.

(vi) Left Electromagnetic Break 243:

The left electromagnetic break 243 has a left break signal input 2431 to receive a control signal from the left break signal output 211 of the microprocessor unit 21 to enable or disable the left electromagnetic break 243.

(vii) Left Large Wheel 244:

The left large wheel 244 is connected with the shaft of the left DC motor 242 to be rolled or stopped with the left DC motor 242.

(viii) Right DC Motor Driver 251:

The right DC motor driver 251 receives a control signal from the microprocessor unit 21 to drive the right DC motor 252 to rotate or stop.

(ix) Right DC Motor 252:

The right DC motor 252 is driven by the right DC motor driver 251 to roll the right large wheel 254 and to further move the electrical wheel chair. Or, the right DC motor 252 stops rotating and is coordinated with the right electromagnetic break 253 to stop the electrical wheel chair.

(x) Right Electromagnetic Break 253:

The right electromagnetic break 253 has a right break signal input 2531 to receive a control signal from the right break signal output 212 of the microprocessor unit 21 to enable or disable the right electromagnetic break 253.

(xi) Right Large Wheel 254:

The right large wheel 254 is connected with the shaft of the right DC motor 252 to be rolled or stopped with the right DC motor 252.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A controlling method for breaking automatically having a safety suspense for an electrical wheel chair, comprising steps of:
pushing a driving-control joystick to produce at least one driving signal when an electrical wheel chair is stopped ;
receiving said driving signal by an electrical wheel chair controller to disable electromagnetic breaks of said electrical wheel chair; and moving said electrical wheel chair.

2. The controlling method according to claim 1,
wherein said driving signal comprising more than one driving signal.

3. The controlling method according to claim 1,
wherein said electromagnetic breaks are disabled to release said large wheels of said electrical wheel chair.

4. The controlling method according to claim 1,
wherein said driving-control joystick is located in said electrical wheel chair controller to be pushed to disable said electromagnetic breaks.

5. The controlling method according to claim 1,
wherein a controlling program of said controlling method is obtained by a computer software and is stored in a memory unit of said electrical wheel chair controller; and
wherein said memory unit is selected from a group consisting of a one-time programmable read-only memory (OTPROM), an electrically erasable programmable read-only memory (EEPROM), a flash memory, and a built-in memory in a central processing unit (CPU).

6. The controlling method according to claim 1,
wherein, after pushing said driving-control joystick to produce at least one driving signal, said electrical wheel chair is controlled by said electrical wheel chair controller to process steps of:
disabling said electromagnetic breaks by said electrical wheel chair controller;
running DC motor drivers; and
rotating DC motors by said DC motor drivers to roll large wheels to move said electrical wheel chair.

7. The controlling method according to claim 1,
wherein said controlling method further comprises steps of:
examining said electrical wheel chair controller to determine whether or not said electrical wheel chair controller is kept being supplied with power; and
a further step is processed
wherein said further step is selected from a group consisting of:
(1) when a power is supplied to said electrical wheel chair controller, examining whether or not any driving signal exists in said driving-control joystick to determine whether or not to keep controlling said electrical wheel chair; and
(2) when no power is supplied to said electrical wheel chair controller, terminating said controlling method.

8. A controlling method for breaking automatically having a safety suspense for an electrical wheel chair, comprising steps of:
releasing a driving-control joystick to terminate driving signal when an electrical wheel chair moves; and
stopping rolling large wheels of said electrical wheel chair then enabling electromagnetic breaks to stop said electrical wheel chair.

9. The controlling method according to claim 8,
wherein said driving signal comprising more than one driving signal.

10. The controlling method according to claim 8,
wherein said electromagnetic breaks are enabled to locked said large wheels of said electrical wheel chair.

11. The controlling method according to claim 8,
wherein said driving-control joystick is located in said electrical wheel chair controller to enable said electromagnetic breaks by releasing said driving-control joystick.

12. The controlling method according to claim 8,
wherein a controlling program of said controlling method is obtained by a computer software and is stored in a memory unit of said electrical wheel chair controller; and
wherein said memory unit is selected from a group consisting of an OTPROM, an EEPROM, a flash memory, and a built-in memory in a CPU.

13. The controlling method according to claim 8,
wherein, after releasing said driving-control joystick to terminate all driving signals, said electrical wheel chair is controlled by said electrical wheel chair controller to process steps of:
stopping driving said DC motor drivers;
stopping rolling said DC motors driven by said DC motor drivers; and
enabling said electromagnetic breaks to stop said electrical wheel chair.

14. The controlling method according to claim 8,
wherein said controlling method further comprises steps of:
examining said electrical wheel chair controller to determine whether or not said electrical wheel chair controller is kept being supplied with power; and
a further step is processed,
wherein said further step is selected from a group consisting of:
when said electrical wheel chair controller is kept being supplied with power, examining whether or not any driving signal exists in said driving-control joystick to determine whether or not to keep moving said electrical wheel chair; and
when said electrical wheel chair controller is no more supplied with power, terminating said controlling method.

15. A controlling method for breaking automatically having a safety suspense for an electrical wheel chair, comprising a large wheel motors action, an electromagnetic breaking action of large wheels, and a suspense time, said suspense time being executed between said large wheel motors action and said electromagnetic breaking action of large wheels to obtain a sequence among said large wheel motors action, said suspense time and said electromagnetic breaking action of large wheels.

16. The controlling method according to claim 15,
wherein a procedure are obtained from said electromagnetic breaking action of large wheels through said suspense time to said large wheel motors action, comprising steps of:
disabling electromagnetic breaks by an electrical wheel chair controller to release large wheels;
suspending for said suspense time;
driving DC motor drivers; and
rotating DC motors driven by said DC motor drivers to roll said large wheels to move an electrical wheel chair.

17. The controlling method according to claim 15,
wherein a procedure are obtained from said large wheel motors action through said suspense time to said electromagnetic breaking action of large wheels, comprising steps of:
stopping driving DC motor drivers by said electrical wheel chair controller;
stopping rolling said DC motors;
suspending for said suspense time; and
enabling electromagnetic breaks to stop said electrical wheel chair.

18. The controlling method according to claim 15,
wherein, during said suspense time, said electrical wheel chair has no moving energy; and
wherein a speed of said electrical wheel chair is slowed down with at least a weight of said electrical wheel chair itself during said suspense time.

19. The controlling method according to claim 15,
wherein said suspense time is set to be a time located between 0.001 second and 100 seconds.

20. The controlling method according to claim 15,
wherein a controlling program of said controlling method is obtained by a computer software and is stored in a memory unit of said electrical wheel chair controller; and
wherein said memory unit is selected from a group consisting of an OTPROM, an EEPROM, a flash memory, and a built-in memory in a CPU.
